(19) United States
(12) Patent Application Publication
(10) Pub. No.: US 2008/0073520 A1
(43) Pub. Date: Mar. 27, 2008

(54) Tip structure for scanning devices, method of its preparation and devices thereon

(76) Inventor: Michail Evgen'evich Givargizov, Moscow (RU)

Correspondence Address: KNOBBE MARTENS OLSON & BEAR LLP, 2040 MAIN STREET, FOURTEENTH FLOOR, IRVINE, CA, 92614, US

(21) Appl. No.: 11/606,442

(22) Filed: Nov. 30, 2006

Related U.S. Application Data
(63) Continuation of application No. PCT/RU05/00291, filed on May 30, 2005.

(30) Foreign Application Priority Data
May 31, 2004 (RU) 2004116249
Jul. 27, 2004 (RU) 2004122785

(51) Int. Cl. G01N 23/00

(52) U.S. Cl. 250/306

(57) ABSTRACT

A tip device for a radiation scanning device is disclosed. The tip device includes a tip substrate including a material transparent to the radiation, where a portion of the substrate has a coating including a material non-transparent to the radiation. A tip is formed on the substrate, where the tip includes a lower aperture formed by an opening in the coating.

### CROSS REFERENCE TO RELATED APPLICATIONS

This application claims priority to and is a Continuation of PCT International Application Number PCT/RU2005/000291, filed on May 30, 2005, designating the United States of America and published in the English language, which claims priority under 35 U.S.C. § 119 to Russian Patent Application Number RU 2004116249, filed on May 31, 2004 and Russian Patent Application Number RU 2004122785, filed on Jul. 27, 2004. The disclosures of the above-described applications are hereby incorporated by reference in their entireties.

### BACKGROUND

1. Field of the Invention

This invention relates to materials science, design and construction of precision instruments for research and technological processes, nanometer-resolution lithography, and diagnostics of various materials. The invention includes the creation of tip structures for scanning instruments, design and construction of such instruments for solving the problems of near-field scanning optical microscopy, optical recording of information, detection and measurement of atomic forces, and nanometer-resolution lithography including highly efficient lithography with the use of multiprobe structures.

2. Description of Related Technology

One of the recent scientific instruments for studying the properties and structures of various thin films is the so-called near-field scanning optical microscope, a modification of a scanning probe device (SPD). One of the most important and well-known SPD modifications is an atomic force microscope (AFM).

The classical scheme for obtaining the image of a sample in near-field optical microscopy (NSOM) is based on the use of a probe consisting of fiber waveguide 1 (FIG. 1) with about 100-nm-long sharpened tip 2 attached to quartz fork 3 (or, more exactly, to one of its prongs 3a). Such a design ensures the control for the probe position with respect to studied surface 4. The other waveguide end, 5, is directed toward radiation source (laser) 6. The radiation from laser 6 reaches end 5 of waveguide I propagates along this waveguide, leaves it through its sharpened tip 2, is transmitted by a studied sample, and, finally, is recorded by a detector (as the wave energy of the transmitted radiation).

The main characteristics of any microscope is its resolution power. The resolution power of NSOM and near-field scanning infrared microscope (NSIM) is determined by two factors. These are: (i)the diameter of sharpened probe tip 2 (a decrease in this diameter results in a decrease of the size of the spot of the transmitted radiation beam 7) and (ii)the mean for control of probe positioning with respect to the surface. Hereinafter, under the term “mean” we will understand a set of necessary techniques and devices to achieve a certain goal (for example, a “mean for sample positioning” or “mean of control”). In another words, “mean” is something that is available and makes it possible for somebody to do something. As was mentioned above, in classical near-field scanning optical microscopy, this problem is solved with the aid of quartz fork 3 similar to a tuning fork. Being exited, the quartz fork vibrates with the natural resonance frequency. With an approach of sharpened probe tip 2 to surface 4, the tip starts interacting with the surface (for example? By an atomic interaction known as or Van der Waals forces). As a result, the oscillation frequency of quartz fork 3 starts deviating from the natural resonance frequency, which is recorded by a servo system as the position of probe 2 with respect to sample surface 4 and the relative coordinates of the probe that fix the surface—probe contact.

Factors (i) and (ii) important in a near-field optical microscope were modified and improved by using various probe modifications [1-5]. Thus, a probe was combined with an AFM cantilever. In [1-5], the optimum system for control of the probe position with respect to the sample was suggested. The feedback of this system was based on a reflected laser radiation and its recording with the aid of a four-position photodiode 12. Today, this most sensitive system is based on a probe (cantilever) consisting of three main elements (FIG. 2). These are: massive solid holder 8, lever 9 (flexible plate with the bending force of about 10⁻¹⁵ H), and tip 10. The necessary sensitivity is ensured by a force that should be applied to lever 9 to bend it (the experiments performed by the IBM showed that this force can attain a value of about 10⁻⁸ H). Laser radiation 11 directed from lever 9 is reflected from its back surface and is incident onto photodiode 12. The initial position of the reflected-beam spot coincides with the cross of the intersecting boundaries of two rows of photosensitive elements of the four-position photodiode. Bend of the lever results in a displacement of the spot recorded by the servo system.

The use of cantilever probes has one more advantage: the tip radius does not exceed 10 nm. Thus, the use of a cantilever probe ensures better parameters of both main elements of a microscope and, thus, also increases its resolution power. Moreover, cantilever probes are more convenient for manufacturing and subsequent exploitation than the classical probes used in NSOM and NSIM (Hereinafter, both terms will be used as “NSOIM”)

And finally, there is one more important advantage of cantilever probes. Cantilever probes allow one to combine the operation of two different microscopes, NSOIM and AFM, in one instrument. Thus, a new scanning instrument allows one to obtain simultaneously two images of different nature from one scanned sample. This, in turn, allows one to study the surface morphology and the internal structure of the sample transparent for the radiation used in high-resolution experiments. The main application field of this new instrument is the study of thin polymer and other films.

To ensure transparency of a probe for radiation 7 used (FIG. 1), a variant of a silicon tip coated with a 20-nm-thick metal layer (FIG. 3) was suggested [1]. In accordance with the theory of propagation of a surface plasmon, the diameter of the resulting radiation beam is of the same order as the thickness of a coating metal layer [1]. The design suggested in [1] considerably increased the “probe efficiency”, i.e., the fraction of the useful radiation transmitted by the probe.

The design suggested in [1] is rather convenient for manufacturing. Some other designs suggested in [2-5] (FIGS. 4, 5, and 7) turned out to be even more efficient. The materials used were transparent for incident radiation 7, with the diameter of the apex aperture being of the same order of magnitude as in [1]. However, the shortcomings of the latter design are associated with the difficulties encountered in probe manufacture and, therefore, impracticality of their widespread use. The technology described in [4, 5] includes numerous complex operations used in manufacture of probes (FIG. 6) that may be used only in NSOIM.

The design of a probe shown in FIGS. 8a and 8b and the instrument on its basis suggested in [6, 7] possess all the advantages considered in [1-5]. The excellent characteristics of this probe such as its simple design (characteristic of the design suggested in [1]) and its high efficiency (characteristic of the designs suggested in [2-5]) make the invention made in [6, 7] quite popular. However, the invention [6, 7] also has some shortcomings: the probe surface has no necessary opaque coating from the tip side and, on the other hand, does not guarantee the absence of such coating on the tip vertex necessary for the formation of a corresponding aperture. The use of such a design results in scattering of the radiation from the whole probe surface so that only a very small fraction of the radiation is transmitted by the tip vertex. This, in turn, considerably decreases the efficiency parameter characterized by the signal/noise ratio.

Moreover, the simple probe designs suggested in [6, 7] do not allow one to study the surface relief of fine structures of the samples with well developed surfaces. This considerably limits the usage of these probes and instruments on their basis. The probe modifications with specially deposited tips [6, 7] considerably complicate the technology of their manufacture. Thus, similar to the inventions made in [2-5], the inventions made in [6, 7] are not widely used.

### SUMMARY OF CERTAIN INVENTIVE ASPECTS

Certain aspects of a probe and an instrument on its basis suggested in the present application combines advantages suggested in [1-7]. At the same time, the new method of probe manufacture suggested in this application allows one to considerably reduce the cost of the final product and, thus, considerably increase the number of its possible users. An instrument on the basis of these aspects allows the use of this instrument for solving various problems.

One embodiment is a tip device for a radiation scanning device. The tip device includes a tip substrate including a material transparent to the radiation, where a portion of the substrate has a coating including a material non-transparent to the radiation, and a tip formed on the substrate, where the tip includes a lower aperture formed by an opening in the coating.

Another embodiment is a method of manufacturing a tip device for a radiation scanning device. The method includes forming a tip substrate including a material transparent to the radiation, at least partially coating the substrate with a material non-transparent to the radiation, forming a tip on the substrate, and forming a lower aperture on the tip by creating an opening in the coating.

Another embodiment is a scanning device including a probe including a holder, a lever, a tip, and an aperture formed on the tip by an opening in a layer of radiation-nontransparent material on the tip. The scanning device also includes a substrate configured to support a sample, means for positioning the probe with respect to the substrate, means for scanning the sample, means for inducing radiation from the sample, means for amplifying the induced radiation, means for analyzing the induced radiation, and first and second radiation sources configured to irradiate the sample.

Another embodiment is a scanning device including a probe including a holder, a lever, a tip, and an aperture formed on the tip by an opening in a layer of radiation-nontransparent material on the tip. The scanning device also includes a substrate configured to support a sample, means for positioning the probe with respect to the substrate, the means for positioning configured to position the tip of the probe so as to contact the substrate on the opposite side of the substrate as the sample, means for scanning the sample, means for inducing radiation from the sample, means for amplifying the induced radiation, means for analyzing the induced radiation, and first and second radiation sources configured to irradiate the sample.

Another embodiment is a scanning device including first and second probes, each including a holder, a lever, a tip, and an aperture formed on the tip by an opening in a layer of radiation-nontransparent material on the tip. The scanning device also includes a substrate configured to support a sample, means for positioning the first and second probes with respect to the substrate, means for scanning the sample, means for inducing radiation from the sample, means for amplifying the induced radiation, and means for analyzing the induced radiation, where the tips of the first and second probes are oriented so as to face one another, the substrate is positioned between the first and second probe tips, the first probe is configured to transmit radiation, and the second probe is configured to receive the transmitted radiation.

### BRIEF DESCRIPTION OF DRAWINGS

FIG. 1. Schematic of a classical probe for NSOIM. 1 light waveguide, 2 sharpened light waveguide tip, 3 quartz fork, 3a prong of quartz fork, 4 sample, 5 light-waveguide end directed to a laser source. 6 laser, 7 laser radiation. FIG. 2. Schematic of a classical probe for AFM. 8 probe holder, 9 probe lever, 10 probe tip, 11 laser, 12 four-position photodiode. S1: back side of probe. S2: front side of probe.

FIG. 3. Prior state of art. Schematic of a cantilever probe for NSOM suggested in [1].

FIG. 4. Prior state of art. Schematic of a cantilever probe for NSOM suggested in [2].

FIG. 5. Prior state of art. Schematic of a cantilever probe for NSOM suggested in [3].

FIG. 6. Prior state of art. Illustration of the method used for manufacture of a cantilever probe for NSOIM suggested in [4]. 1 single-crystal silicon substrate, 2 protective film of thermal silicon dioxide, 3 pyramid-like deepening, 4 film of thermal silicon dioxide, 5 tip, 10 flexible layer, 11 polyimide film, 12 polyimide film, 21 substrate, 22 buffer n-InP layer, 23 active InGaAsP layer, 24 coating p-InP layer, 25 external p-InGaAs layer, 27 insulating layer, 28 waveguide, 29 masking layer, 30 applied electrode.

FIG. 7. Prior state of art. Schematic of a cantilever probe for NSOIM suggested in [4]. 5 tip, 10 flexible layer, 20 laser, 21 substrate, 27 insulating layer, 28 waveguide, 30 applied electrode.

FIGS. 8a, b. Prior state of art. Schematics of cantilever probes for NSOIM suggested in [6, 7]. 100 probe, 101 lever, 102 free end of the holder, 103 holder stage, 104 metal film, 105 scattering tip, 105b a small part of scattering tip.

FIGS. 9a, b. Cross section of the cantilever probe for a device with a scanning probe hereinafter called an SPD probe. 8 probe holder, 9 probe lever, 10 probe tip, 13 radiation-transparent layer, 14 radiation-nontransparent metal coating, 15 lower aperture at the tip vertex.

FIGS. 10a, b. SPD probe without metal coating on its back side or partly without such coating. 8 probe holder, 9 probe lever, 10 probe tip, 13 radiation-transparent silicon dioxide layer, 14 radiation-nontransparent metal coating, 15 aperture at the tip vertex, 16 upper aperture at the back side of the probe holder.

FIGS. 11a, b. SPD probe with an additional functional layer. 8 probe holder, 9 probe lever, 10, probe tip, 13 transparent surface layer, 13a nontransparent insulating layer, 14 radiation-nontransparent metal coating on the front surface of the probe, 14a radiation-nontransparent (or partly radiation-transparent) metal coating on the back side of the probe, 15 lower aperture at the tip apex, 16 upper aperture at the probe holder from the back side, 17 and 18 functional layers on the back and front sides of the probe.

FIG. 12a. Tip apex of an SPD probe made of materials with different refractive indices. 13 transparent surface layer, 14 radiation-nontransparent metal coating on the face side of the probe, 15 lower aperture at the tip apex, 19 bulk material of the probe with the refractive index different from the refractive index of the surface layer in which the radiation propagates, 20 radiation propagating along the probe surface, 21 radiation transmitted by the lower aperture of the probe.

FIGS. 12b, c. SPD probe made of a material with different refractive index. 4 sample, 8 probe holder, 9 probe lever, 10 probe tip, 14 radiation-nontransparent metal coating applied to the front surface of the probe, 15 lower aperture at the tip apex, 22 material on the surface of a transparent tip with the refractive index different from the refractive index of the probe material along which the radiation propagates in the probe, 23 substrate material into which (from which) the radiation enters the sample (leaves it) through the lower aperture.

FIGS. 13a, b. Illustrating the method of manufacture of a silicon nitride cantilever probe. A-E are the main steps. 13a (100)-oriented silicon substrate, 13b pyramidal deepening, 13c deposited silicon nitride layer and the tip contour formed, 13d deposition of a silicon nitride layer and lever formation, 13e formation of a glass holder, 13f formation of silicon dioxide layer.

FIGS. 14a, b, c, d. Fragment of a device based on an SPD cantilever probe (hereinafter called a “device fragment”) and different modes of the radiation incidence. 4 sample, 8 probe holder, 9 probe lever, 10 probe tip, 12a objective of the NSOIM detector, 13 transparent surface layer, 14 radiation-nontransparent metal coating, 15 lower aperture at the tip apex, 16 upper aperture at the back side of the probe holder through which the radiation enters the probe bulk or its transparent surface layer, 20 radiation propagating along the probe surface, 21 radiation which leaves the probe through the lower aperture, 21a characteristic radiation which goes out from the sample, 24 radiation incident onto the back side of the probe, 25 direction of the radiation propagation in the transparent surface layer of the probe, 26 radiation incident onto the back side of the probe and penetrating the probe bulk or its surface layer through the upper aperture.

FIGS. 15 a,b,c. Device fragment with mean for probe positioning with respect to the sample combined with the mean for work with this sample. 13 transparent surface layer, 14b, c radiation-nontransparent metal coatings on the lever, 14d partly radiation-nontransparent metal coating on the lever, 15 lower aperture at the tip apex, 20 radiation propagating in the probe or in its transparent surface layer, 21 radiation which leaves the probe via the lower aperture, 24 radiation incident onto the back surface of the probe, 27 radiation reflected from the nontransparent material applied to the front surface of the lever (FIG. 15a), radiation reflected from the nontransparent material of the probe (FIG. 15b), or radiation reflected from partly nontransparent material (FIG. 14a) applied to the back side of the lever (FIG. 15c).

FIGS. 16a, b. Device fragment in the case where the radiation is incident through the upper aperture. 8 probe holder, 13 transparent surface layer, 14 radiation-nontransparent metal coating applied to the face side of the probe, 15 lower aperture at the tip apex, 16 upper aperture at back side of the probe holder, 20 radiation propagating in the probe (or in its transparent surface layer), 21 radiation that leaves the probe through the lower aperture, 24 radiation incident at the back side of the probe, 25 direction of radiation propagation in the transparent surface layer of the probe, 26 radiation incident onto the back side of the probe and penetrating the probe material or its surface layer through the upper aperture, 27 radiation reflected from the nontransparent material applied to the back side of the lever, 28 clamped contact, 29 device holder.

FIG. 17. Device fragment in which the radiation is incident from the side of the sample and is transmitted by this sample. 4 sample, 8 probe holder, 14 radiation nontransparent metal coating on the face side of the probe, 15 lower aperture at the tip apex, 16 upper aperture on the back side of the probe holder through which the radiation leaves the probe, 20 radiation propagating in the probe, 24 radiation incident to the back side of the probe, 27 radiation reflected from the non-transparent material applied onto the back side of the lever, 30 radiation incident onto the sample from the side opposite of the probe, 31 radiation transmitted by the sample, 32 radiation from the sample that entered the lower aperture, propagated along the probe, and left it through the upper aperture.

FIG. 18. Device fragment with at least two radiation sources necessary for work with the samples. 14 radiation nontransparent metal coating of the front side of the probe, 15 lower aperture at the tip apex, 20 radiation propagating along the probe, 21a, b spots from two radiation sources in the plane normal to the tip axis after the radiation exit through the lower aperture, 24a, b radiation from two independent sources incident onto the back side of the probe, 33 region of spot overlap.

FIGS. 19a, b. Device fragment with the mean for obtaining interference of the static or dynamic radiation necessary for work with samples. 10 tip, 11 radiation source, 11a mirror providing the formation of two coherent beams from one source, 14 metal coating nontransparent for the radiation on the front side of the probe, 15 lower aperture at the tip apex, 20 radiation propagating along the probe, 21a two beams of coherent radiation, 22 material at the surface of a transparent tip with the refractive index different from the refractive index of the material used for preparation of the probe-tip bulk in which the radiation propagates, 24 two beams of coherent radiation incident onto the back side of the probe, 34 interference fringes.

FIG. 20. Device fragment with the mean for generation of a radiation in the probe. 13a layer of nontransparent dielectric, 14 radiation-nontransparent metal coating on the front side of the probe, 14a radiation-nontransparent metal coating on the back side of the probe, 15 lower aperture at the tip apex, 17 functional layer, 20 radiation propagating along the probe, 21 radiation which leaves the probe through the lower aperture, 24 radiation incident onto the back side of the probe, 27 radiation reflected from the nontransparent material applied to the back side of the lever, 35 flux of particles or radiation incident onto the functional layer and generating the radiation propagating along the probe.

FIGS. 21a,b. Device fragment with the mean for generating radiation in the sample and a radiation amplifier located in the probe. 4 sample, 8 probe holder, 10 tip, 14 radiation-nontransparent metal coating on the front side of the probe, 15 lower aperture at the tip apex, 16 upper aperture on the back side of the probe holder through which the radiation leaves the probe, 17, 18 functional layers, 20 radiation propagating in the probe, 23 thin transparent substrate, 24 radiation incident onto the back side of the probe, 27 radiation reflected from the nontransparent material applied to the back side of the lever, 31 characteristic radiation of the sample, 32 characteristic radiation of the functional layer propagating along the probe and leaving it through the upper aperture, 36 radiation used to irradiate the functional layer, 37 radiation propagating along the probe and used to irradiate the functional layer, 38 radiation used to irradiate the sample, 39 characteristic radiation of the functional layer formed as a result of the enhancement of the characteristic radiation of the sample entered through the lower probe aperture.

FIG. 22. Device fragment in which the radiation used for work with samples is incident from the probe located on the sample side opposite with respect to the probe and used for the analysis of the radiation transmitted by the sample. 4 sample, 8a, b probe holder, 13 transparent surface layer, 14a, b radiation-nontransparent metal coating on the front side of the probe, 15a, b lower aperture at the tip apex, 16a, b upper aperture at the back side of the probe holder through which the radiation leaves the probe bulk, 20 radiation propagating along the probe surface, 21 radiation which left the probe through the lower aperture, 23 thin transparent substrate, 24a,b radiation incident onto the back side of the probe, 25 directions of radiation propagation in the transparent surface layer of the probe, 26 radiation incident onto the back side of the probe and incident onto the material through the upper aperture, 27a, b radiation reflected from the nontransparent material applied to the back side of the lever, 31 radiation transmitted by the sample, 32 radiation from the sample which entered the lower aperture, propagated along the probe, and left it through the upper aperture, 40 one of the directions of the sample motion during its scanning by the device.

FIG. 23. Device fragment in which the radiation used for work with samples enters the sample through the probe which is in contact with one of the substrates, whereas the radiation transmitted by the sample is accepted by another probe contacting with the substrate located on the other side of the sample placed between these two substrates. 4 sample, 8a, b probe holder, 9a, b levers, 10a, b tips, 23a,b transparent thin substrates, 26 radiation incident onto the back side of the probe, 32 radiation transmitted by the sample is incident onto the probe through the lower aperture, propagates along the probe, and leaves it.

FIG. 24. Fragment of a multiple structure with incorporated probes. 8 probe holders, 9 levers, 10 tips, 14 nontransparent coating on the front side of the substrate.

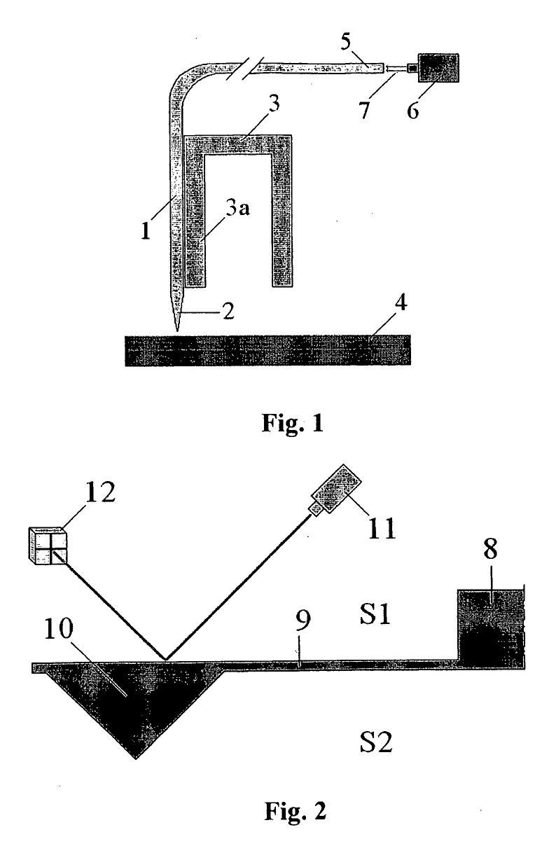

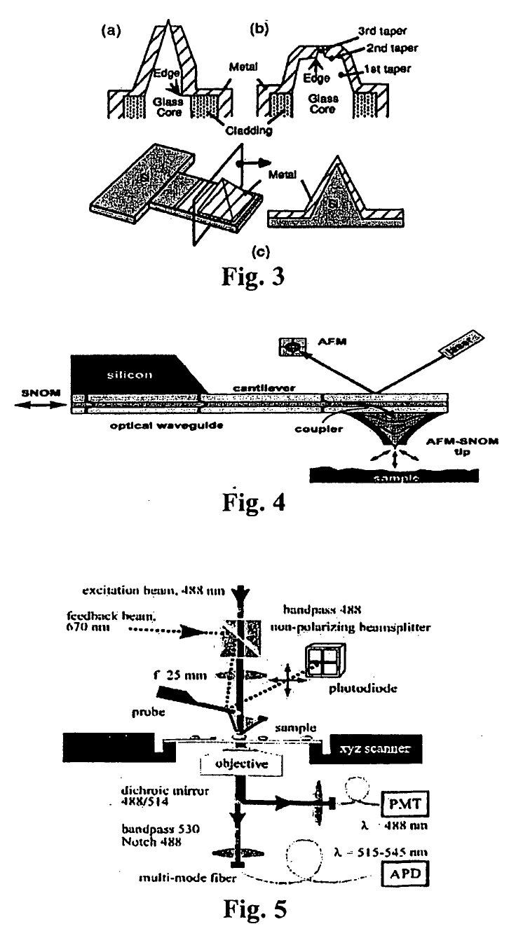

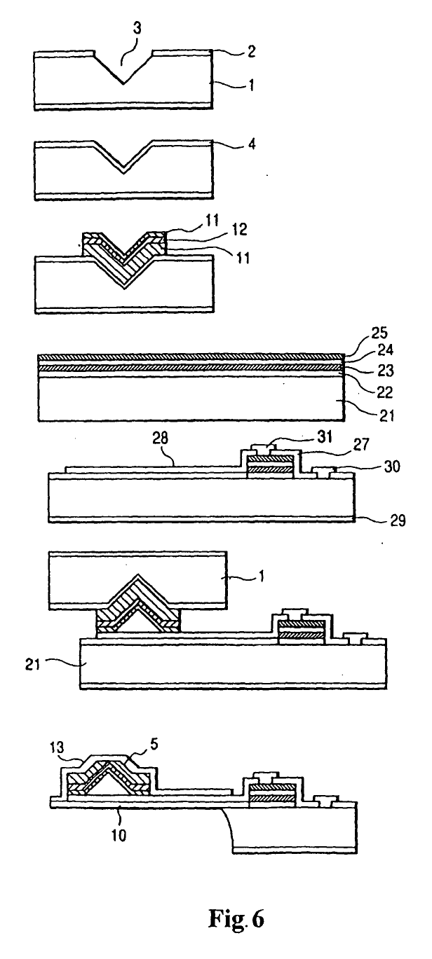

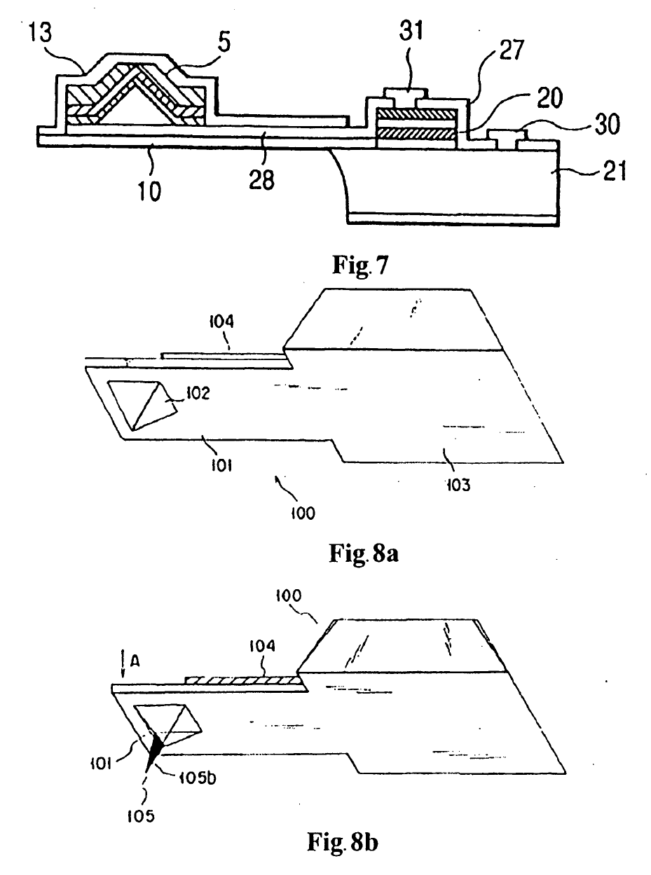

### DETAILED DESCRIPTION OF CERTAIN INVENTIVE EMBODIMENTS.

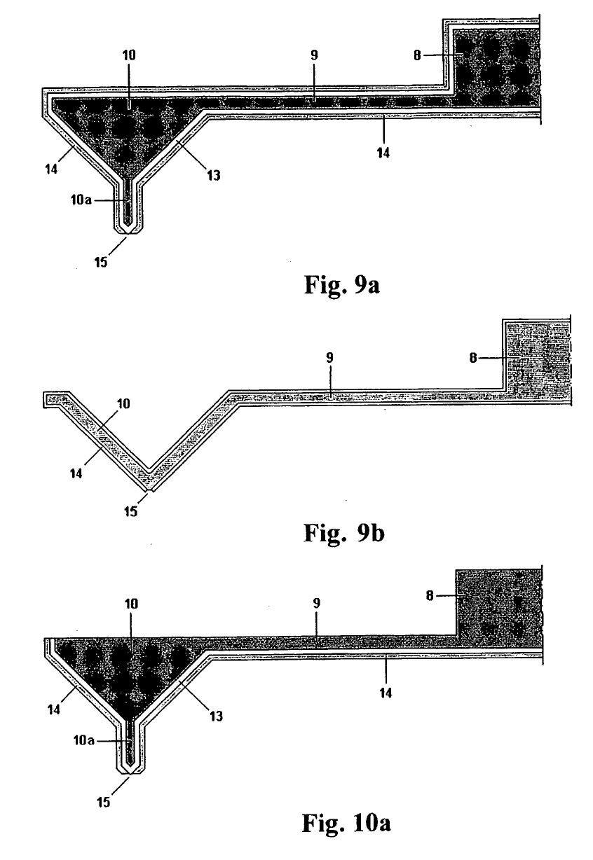

Though the aspects presented herein may be applied to others, we consider two main types of probes for scanning devices (hereinafter referred to as probes). Both probes include a massive holder 8, flexible part 9 (lever), and tip 10 located on this lever (FIGS. 9a, b).

One of these probes is made of silicon nontransparent for the radiation conventionally used in near-field scanning optical microscopy, namely, for a visible radiation generated by a laser source. In accordance with the present invention, this probe is coated with a layer of material 13 transparent for this radiation (FIG. 9a). An example of a suitable material for this layer is thermal silicon dioxide deposited on the probe surface. In this case, a certain part (not the prevailing one) of the radiation may also propagate in silicon. Obviously, the refractive index of silicon considerably exceeds the refractive index of the silicon dioxide layer. Hereinafter, considering radiation propagation in the probe, we refer to the main channel of its propagation, i.e., the radiation propagation in the silicon dioxide layer.

The second type of the probe is made of the material transparent for the radiation used (FIG. 9b). A suitable material for this probe is silicon nitride.

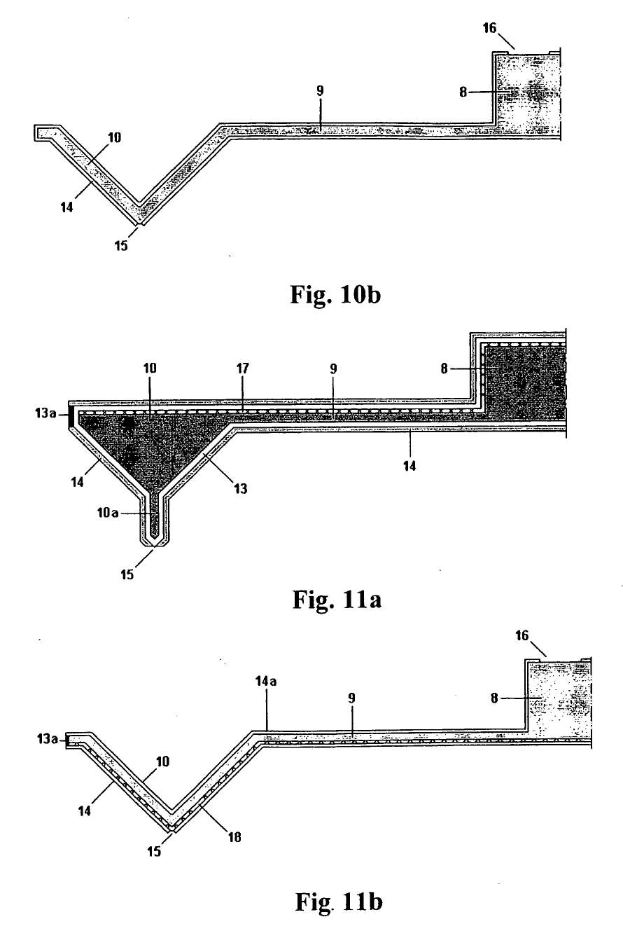

Both types of probes are coated with radiation-nontransparent material 14. This material may be any metal (silver, gold, aluminum, etc.) or any other radiation-nontransparent material. One solution is an aluminum coating. In this case, the coating at the tip apex may be either absent (which results in the formation of aperture 15) or may be present in small amounts, which guarantees the propagation through the tip apex of the amount of radiation sufficient for its detection. For both types of probes, the coating may be absent either on the whole back side of the probe tip (FIG. 10a) or only at some its portions, in particular, on the holder (FIG. 10b), which reflects the formation of upper aperture 16 (different from lower aperture 15).

One of the variants of implementation of the present invention requires the existence of layer 17 on the back side (FIG. 11a) of the probe surface below the nontransparent or partly nontransparent coating or existence of layer 18 on the front side (FIG. 11b). This layer may be selected as a luminescent layer (the source of radiation) then coated with a layer nontransparent for one type of radiation (reflecting this radiation) and transparent for another type of radiation or a flux of particles. In another case, this can be a layer of a material enhancing the incident radiation. This radiation may be, e.g., a radiation generated in a sample with or without a certain actuator. This procedure is necessary for preliminary enhancement of the radiation incident onto the lower aperture to ensure its propagation in the transparent probe bulk or in the transparent surface layer and then to enhance it even more after the exit of the radiation from the transparent parts. To provide generation of a radiation and its enhancement, the design envisages the creation of a potential difference between conducting coatings 14 and 14a and also between these coatings and the probe material (if the probe is made of a conducting material).

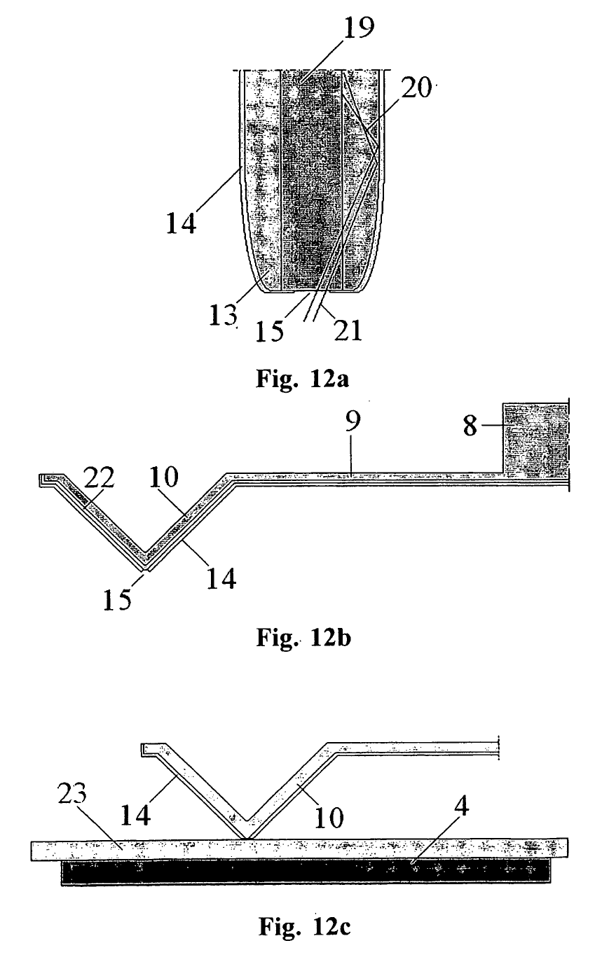

As shown in FIG. 12a, some embodiments include the possible presence of material 19 with the refractive index different from the refractive index of probe material 13 in which radiation 20 propagates near the lower aperture at the tip apex. In this design, radiation 20 first propagates in silicon 19 (with the refractive index higher than in silicon dioxide layer 13) and then passes through the lower aperture 15. Some embodiments also envisage another design illustrated in FIG. 12b. In this design, the tip of the probe made of the material transparent for radiation has layer 22 with different refractive index. This layer is located between the tip material 10 and nontransparent layer 14 forming lower aperture 15. The choice of the aperture size, material, and the portion of this material with the refractive index different from the refractive index of the medium of the radiation propagation in the probe (transmitting a radiation wave) are the most important elements for formation of the optimum transverse size of the radiation beam 21 during its passage through lower aperture 15. To optimize the solution of this problem, locate 4 on substrate 23 made of the material with its own refractive index (FIG. 12c). In particular, substrate material 23 can be the material of the probe transmitting the radiation (the probe surface). In other words, if a probe is made of silicon nitride, the substrate may also be made of silicon nitride. If the radiation propagates in the surface silicon dioxide layer, the substrate may also be made of silicon dioxide. Alternatively, the substrate and the surface layer can be made of different materials. The additional degree of freedom arising in the selection of the above physical and geometrical parameters of the materials located near the lower aperture, allows one to optimize the selection of the materials for work with different samples and to attain the maximum possible resolution power of the device.

A probe made of a nontransparent material, e.g., silicon, may be manufactured by any method. To form a layer transparent for radiation, the probe is coated with a silicon oxide layer that can readily be obtained by silicon oxidation. For example, the probe thus obtained, which is often called a cantilever, may be oxidized in the oxygen atmosphere at typical temperatures ranging from 600 C. to 1200 C. The necessary layer thickness depends on the temperature and duration of oxidation. To provide the free propagation of radiation with a wavelength, e.g., of about 500 nm it is sufficient to form a 1 μ thick oxide layer. Once the radiation-transparent surface layer is obtained, the probe is coated with radiation-nontransparent material either partly (its front side, i.e., from the side of the tip) or completely (on both sides). A method for making such coating of metal (aluminum, gold) sputtering onto the probe surface. Performing sputtering onto the front surface at a certain angle to the tip axis, one may reach different results: the tip apex would be either not coated with the sputtered metal or the layer of the sputtered and deposited material would be so thin that it would transmit sufficient fraction of the radiation. Another method of obtaining sufficient transparency of the tip apex after metal sputtering is the creation of the lower aperture with the aid of directional focused beam of particles. In this case, a focused ion beam may be used. Finally, a transparent tip apex may be obtained as follows. It may be advantageous to ensure the contact of the tip with the deposited nontransparent diamond, sapphire (corundum), or silicon carbide surface layer with a smooth surface. These materials are rather strong, their surfaces may be made smooth. All these materials are transparent, which may be beneficial for implementation of the controlled formation of an aperture. In some instances, the aperture may readily be obtained if one ensures the contact between the tip apex and the above materials. In this case, it is also possible to form an aperture of minimal size. If one manages to provide the tip motion with respect to the surface and also its contact with this surface, it becomes possible to remove the surface layer from the tip apex mechanically and, thus, form a larger aperture. The size of this aperture does not generally exceed the curvature radius of the tip apex.

Bringing up of the probe to the working order, i.e., forming an aperture by the mechanical removal of the nontransparent material from the tip, depends on the conditions of probe manufacture and its operation. It can be made either at the stage of probe manufacture or by a user himself directly in the scanning device. In the latter case, the user places the probe into a scanning device and inputs the necessary information to the controlling program which, if necessary, brings the probe to the serviceable condition. The procedure includes lowering of the probe onto a special flat surface of the material located near the sample holder and the controlled removal of the necessary part of the nontransparent material from the tip surface. The controlled removal of the material allows for the radiation passage through a newly formed aperture and its analysis in the process of aperture formation.

It is also possible to form the lower aperture at the tip apex by controlled evaporation of a certain part of the nontransparent material from the tip apex. With this aim, one may apply an electric current in the mode of emission from the tip apex through the nontransparent layer (in most cases, a metal layer). In some embodiments, this is be performed in vacuum but this may not be necessary. For quality (controlled) removal of the material, one may introduce an inert gas (argon, hydrogen, or helium) into vacuum. The emission current passing through the tip apex heats it, which results in the material evaporation from the tip apex. Depending on the kind of the material and gas, the current may be applied in the direct or reverse direction.

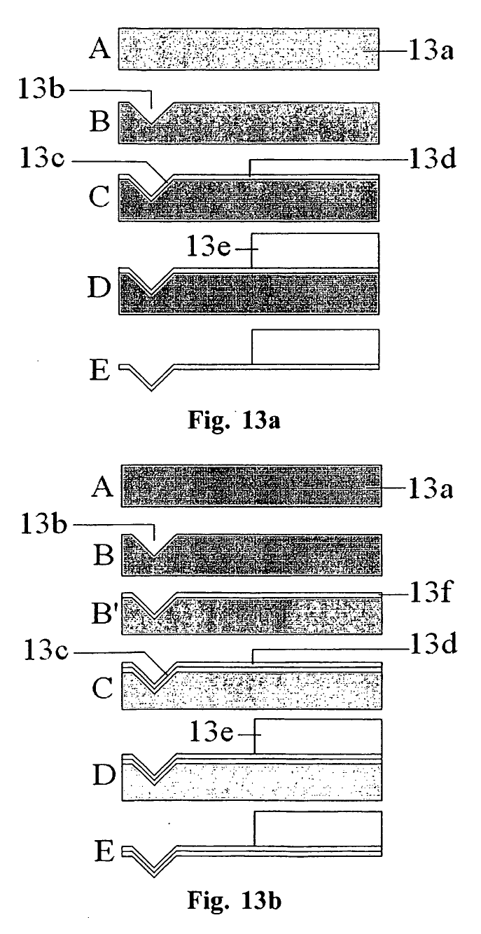

Along with the above variant of manufacture of the probe whose transparency is guaranteed by the surface layer, the some embodiments also consider the method of making the tip with a material such as silicon nitride, a material transparent for the radiation used in near-field scanning optical microscopy. The technology of preparation of such a probe is illustrated by FIGS. 13. a-e. An example of the main stages of the technological process are as follows. First, a pyramidal deepening 13b (B) is made in (100)-oriented silicon wafer 13a (A). Then a silicon nitride layer (C) is deposited and a contours of future tip 13c and lever are formed. The same side D is coated with glass forming the massive part of a future probe, i.e., its holder 13e. After this procedure, silicon 13a is etched away (liquid etching). The surface of such a probe is coated with radiation-nontransparent material as was described above (material deposition). It is also possible to use other methods of material application such as vapor-phase deposition, magnetron sputtering in plasma, etc.

In some embodiments, there may be a material on the surface of the transparent tip with the refractive index different from the refractive index of the tip material along which the radiation propagates in the probe. To ensure the presence of silicon dioxide on the front surface of a silicon nitride tip in the technology illustrated by FIG. 13b (A-E), one may add one more intermediate stage, B, after the formation of a deepening in silicon wafer 13a, but before the deposition of silicon nitride (C), the silicon wafer may be oxidized to form oxide layer 13f (FIG. 13b). The complete removal of silicon 13a leaves only oxide layer 13f at the surface of the silicon nitride tip.

Some embodiments also envisage a probe with a mean either for generation of its own radiation or the enhancement of the incident radiation. With this aim, prior to the application of a nontransparent layer, the probe surface or its certain part are coated with the layer of the material, which, being exposed to a flux of particles or radiation, either generates its own radiation or enhances the incident radiation.

Some applications include a near-field scanning optical microscope and a device for optical storage of information.

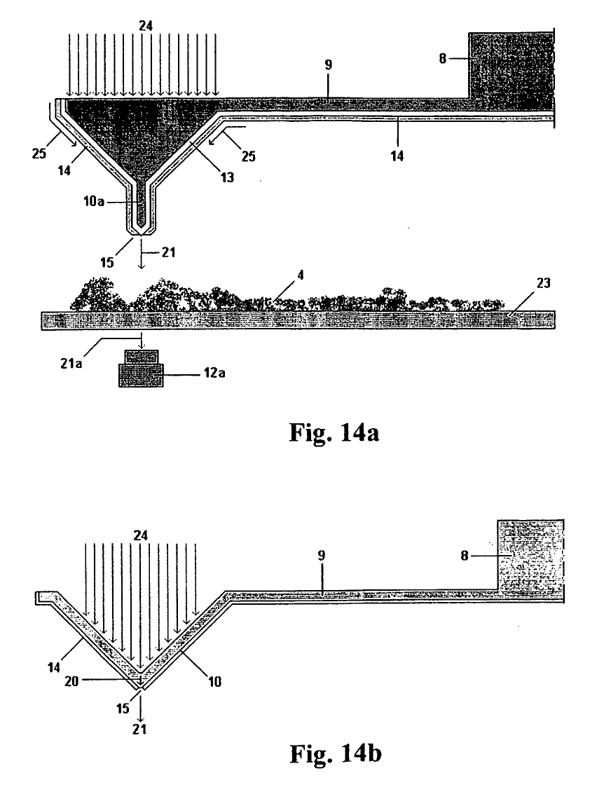

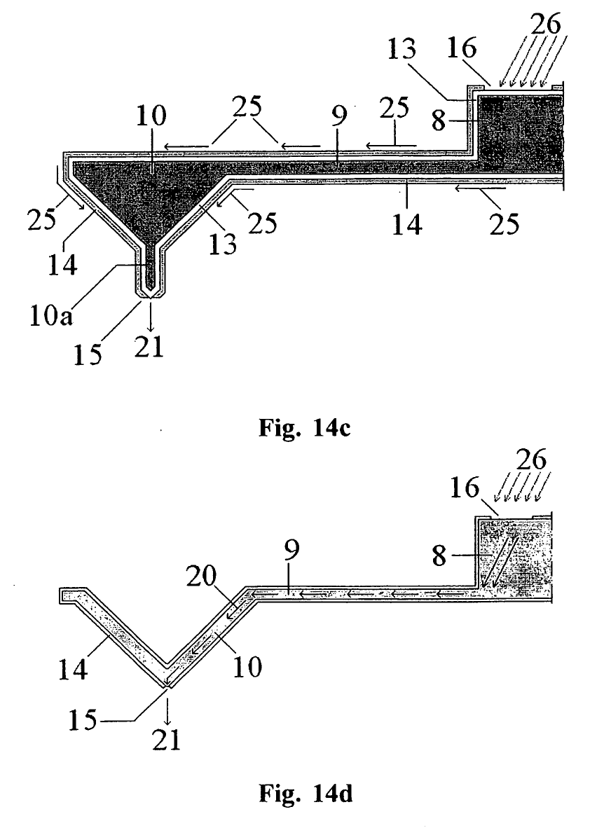

One scanning device may be described as follows. A probe that can be made of radiation-nontransparent material (e.g., silicon) with the surface transparent for radiation (e.g., silicon dioxide) is coated with a thin layer of nontransparent material. Then a part of the nontransparent material is removed by one of the above methods to form the exit aperture. In addition, the nontransparent coating or its part may also be removed from the probe holder from the side opposite to the tip. Then the back side of the probe is illuminated with radiation 24 (FIGS. 14a, b) or radiation 26 (FIGS. 14c,d). The radiation is either distributed over the whole surface of the back side of the probe or penetrates radiation-transparent surface layer 13 or the transparent bulk through entrance aperture 16 and propagates along the probe or its surface to exit aperture 15. The radiation that leaves the aperture is used for further work with sample 4. In one case, this radiation penetrates the sample material and modifies it. This may be used for recording information by an optical method. In another case, the radiation penetrates the sample bulk and leaves it as radiation 21a with the characteristic intensity incident onto objective 12a of the NSOIM radiation detector recording its parameters. In other words, to each sample point with the coordinates (x,y) there correspond a certain intensity of the transmitted radiation and a certain vertical coordinate z. Scanning the whole surface, one obtains a certain intensity distribution of the transmitted radiation, and, finally, a sample image. In devices which store the information, the above procedure may be considered as reading of the information on its carrier, i.e., on a substrate with a sample. A sample can be a flat plastic plate which can change its properties under the action of an incident radiation. In materials whose properties are studied after the record of the radiation-intensity distribution over the whole surface, an image of a sample and its surface morphology (i.e., a surface relief) is formed.

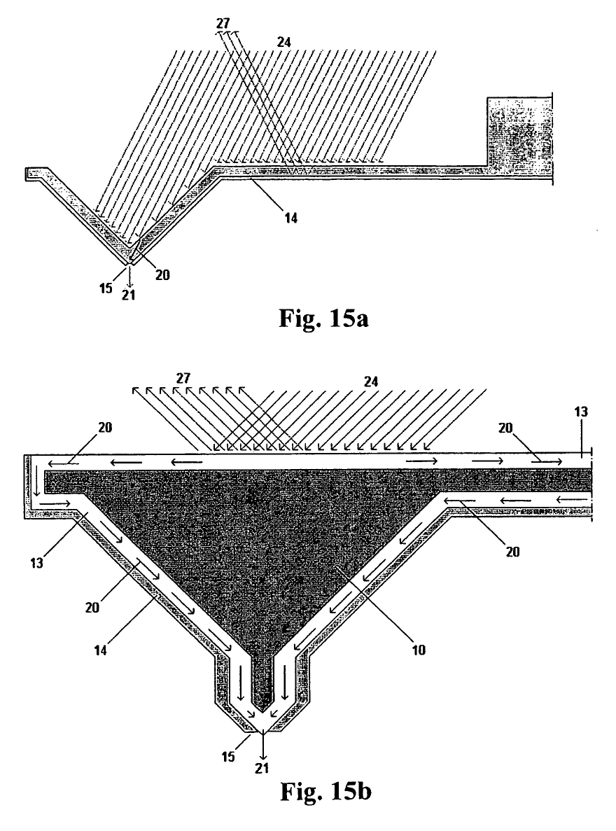

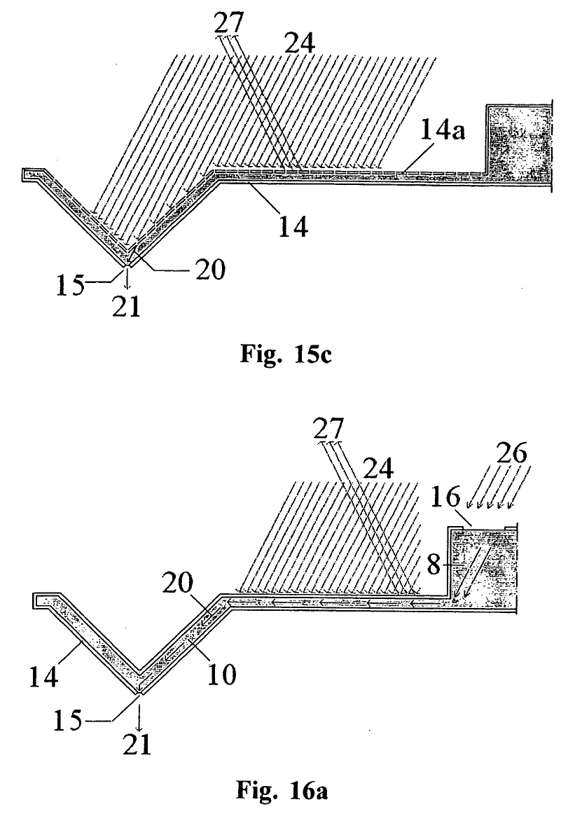

One of the possible variants of a scanning device based on the present invention combines the mean for sample scanning with the mean for control of the probe positioning relative to the sample. If the laser radiation is incident onto the back surface of the probe, then, in accordance with FIGS. 15a-c, part of this radiation, 27, is reflected (a signal for the means of control of the probe positioning) and some radiation part, 20, is transmitted by the probe (or its transparent surface) and goes out through the lower aperture 15 at the tip apex as radiation 21 (radiation incident onto the sample).

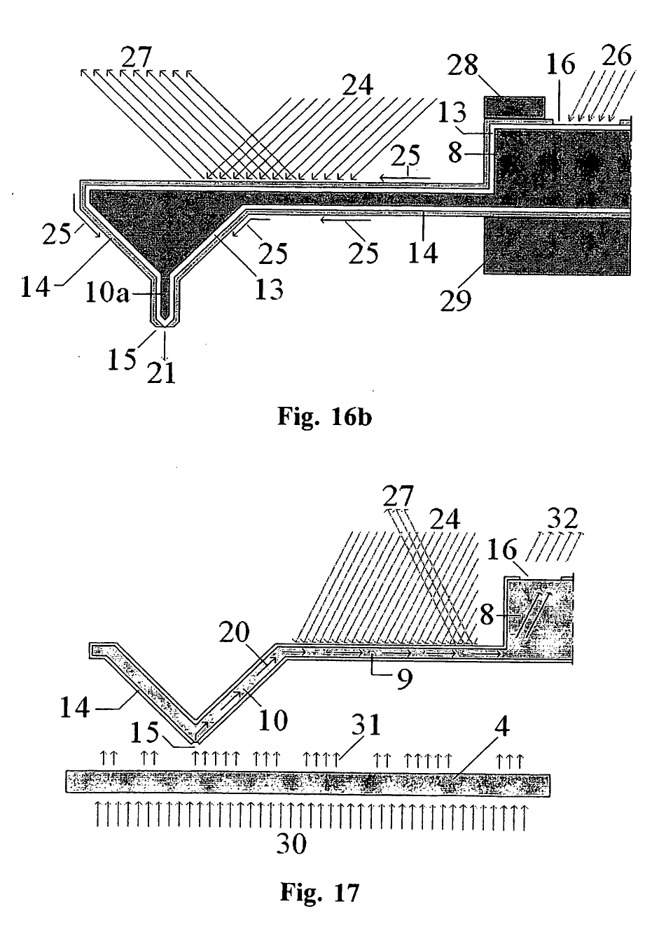

In another geometry of a scanning device, radiation 24 (FIGS. 16a, b) from a source is incident onto the lever from the back side of the probe, whereas radiation from another source 26 is incident onto holder 8 on the back side of the probe with upper aperture 16. Through this aperture, radiation 20 enters the probe (or propagates along its surface) and leaves the probe as radiation 21 incident onto the sample through lower aperture 15. The reflected radiation, 27, of the first source is used in the means of control of probe positioning. It is possible to represent both sources by the same laser. In this case, the beams are separated with the aid of a system of lenses. To bring a scanning device to the serviceable condition, some embodiments envisage such a cantilever probe with a sufficiently long holder, which is useful to improve the contact between clamp contact 28 and holder 8 with holder 29 of the scanning device. It is necessary for focusing radiation 26 from the second source onto upper aperture 16. As a rule, the cantilever probe in an AFM has the size ranging within 3-4 mm, whereas the probe size for scanning devices in the one embodiment ranges from 5 to 6 mm.

Some embodiments also envisage analysis of the radiation transmitted by a sample with the aid of the probe. In this case, radiation 30 is incident onto sample 4 (FIG. 17), is transmitted by this sample and acquires intensity 31, and then, after passing aperture 15, reaches the probe. Radiation 20 propagates either along the probe or along its surface (for silicon probes) because of nontransparent coating 14, and then goes out through upper aperture 16 of the probe located on the back side of holder 8. The means of control of probe positioning relative the sample uses radiation 24 and reflected radiation 27 and allows one to scan the whole sample surface. For information carriers, this method allows one to read the data recorded by the sample material.

Some embodiments envisage along with the designs considered above and their modifications, also the design of a device which allows one to attain even better results—a higher resolution and efficiency by the means of interference describe below including the mean of dynamic interference.

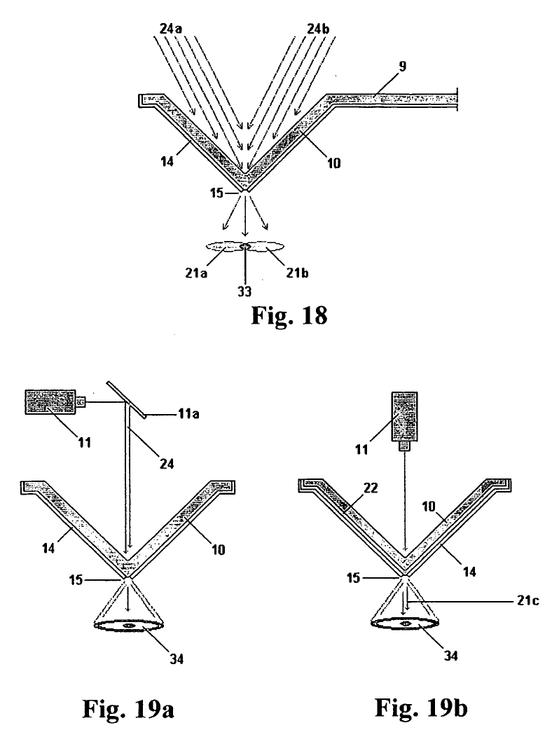

It is suggested to use two sources of incoherent radiation 24a,b (FIG. 18). Radiation from these sources passes through lower aperture 15 and forms two spots on the sample surface. Each spot has its radius and is characterized by the same intensity in the plane normal to the beam direction. The source geometry can be chosen in a way to provide a rather small spot overlap with a double intensity. Tuning the NSOIM detector with the aid of objective 12a (FIG. 14a) to a threshold radiation intensity (total intensity provided by the two sources) below which no radiation can be detected, it is possible to increase the device resolution. This device can be used, for example, for lithography works (or information storage). The selection of the threshold intensity is determined by the energy necessary for the proceeding of the chemical reaction in the exposed photoresist (or the ability of the sample material (information carrier) to change its properties). Using several radiation sources arranged along the circumference with the center coinciding with the tip axis, it is possible to attain the desired shape of the spot overlap and its high intensity. It is beneficial to use the sources with circular exit apertures. In some embodiments, the center of such apertures lie at the tip axis. Varying the circular aperture—probe distance (i.e., approaching or moving away the aperture along the tip axis), it is possible to obtain the resulting optimum spot and, thus, determine the position of its “focus” (maximum of radiation).

The resolution power of scanning devices can also be increased using interference. To ensure the interference conditions for the radiation incident onto the sample, one can decrease the spot size on the sample. This is attained at the interference maximum. In some embodiments, the ideal spot has a circular shape and is located in the center of the concentric interference fringes. Some embodiments use a design with two sources of coherent radiation (FIGS. 15a, b). These sources may be described as follows. Laser source 11 generates a coherent radiation which is split by mirror 31 into two coherent beams 24. These beams pass the probe and leave it through lower aperture 15 of the probe. The resulting radiation forms a centrosymmetric interference pattern consisting of concentric fringes and a central circular spot. The appropriate selection of mirror 31 and its positioning with respect to laser source 11 results in the most intense spot in the sample plane having a circular shape of a small radius, which ensures an increase in the device resolution. Then, objective/lens 12a (FIG. 14a) is tuned, as was described above, to the threshold intensity of the radiation, and the spot starts acting as an independent element of the device (it brings all the remaining elements of the interference pattern beyond the level of a useful signal). The same effect may also be attained by using the second probe located on the other side of the sample with respect to the probe forming the interference pattern (Some embodiments are described below). Then, it is useful to bring the central circular spot into the center of the lower entrance aperture of the probe tip. FIG. 19b illustrates the split of the radiation into two coherent beams necessary for the further formation of an interference pattern with the aid of thin layer 22 at the tip surface prior the exit of the radiation 20 from exit aperture 15. Such a layer may be, in particular, an oxide layer at the surface of a silicon nitride tip. One technology for obtaining such tip is illustrated by FIG. 13b.

An interesting consequence of this device modification is the formation of a dynamic pattern with the aid of dynamic interference. In this case, the maximum of the radiation incident onto a sample is characterized by the displacement with time in the form of diverging concentric circles. This is especially important in the in situ experiments. A constant displacement of the interference fringes with time allows one to perform frame-by-frame analysis of the processes taking place in a sample.

The intersection of double spots and the interference spot considered above may be used when working with classical NSOIM probes (light guides). However, particularly good results are attained with the use of the probe described herein.

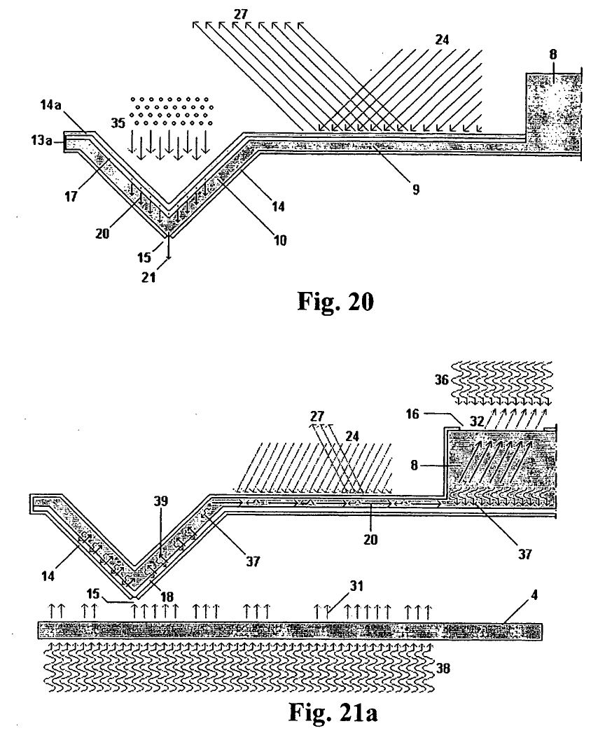

Some embodiments use the device modification (FIG. 20) with the mean of generation of a radiation in the probe. If a particle flux of particles (e.g., electron flux in vacuum) or radiation 35 is incident onto the back side of the probe, it is transmitted by transparent coating 14a and penetrates functional layer 17. In this layer, this flux (radiation) excites radiation quanta 20, which pass through exit aperture 15 as radiation 21 then used to irradiate the sample. In this case, coating 14a is not transparent for radiation 24 used for the control of the probe positioning with respect to the sample. This design also increases the probe efficiency.

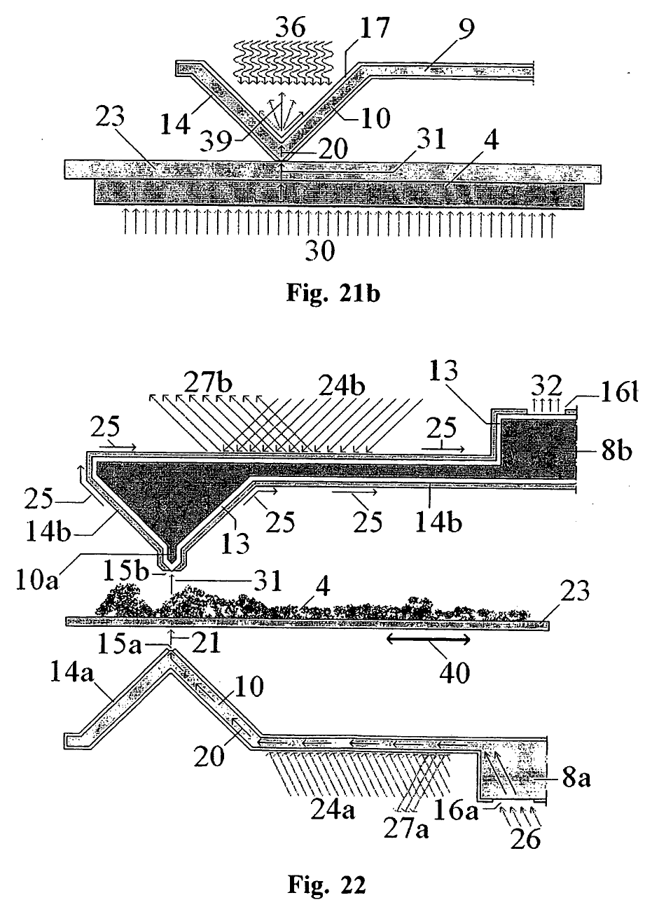

It is well known that illumination of a sample with a radiation flux and analysis of the transmitted light energy with the aid of a NSOIM probe, makes the intensity of the transmitted radiation rather high so that it can readily be recorded. However the signal/noise ratio is rather low. In the case of generation of characteristic radiation in the sample, the illumination intensity is rather low, but the signal/noise ratio is rather high because despite a low signal from the sample it is well seen against the dark background. In other words, the contrast is rather high. The devices suggested herein may also use a mean for enhancing this signal. One modification envisages the location of the mean for signal “amplifier” in the probe. In FIG. 21a, sample 4 is irradiated with radiation 38. As a result, the sample generates characteristic radiation 31 which enters lower aperture 15 of the probe. In turn, functional layer 18 at the tip surface is irradiated with radiation 36 penetrating the probe through upper aperture 16 in holder 8 from the back side of the probe. Then radiation 37 propagates along the probe and reaches functional layer 18. As a result of such irradiation, the electrons of functional layer 18 are excited and acquire a quasi-stationary state (are captured by a trap with a higher energy). A quantum of characteristic sample radiation 31 incident onto the functional layer loses an electron from the quasi-stationary excitation level. As a result, several radiation quanta pass to their stationary energy level (stationary orbit). The emitted radiation quanta 39 propagate along the probe, reach upper aperture 16, are recorded by the receiving objective of a scanning device, and are analyzed. In other words, a quantum of the characteristic sample radiation generates several quanta of the characteristic functional-layer radiation recorded by a photodetector.

One implementation of the above scheme is the design illustrated by FIG. 21b. The sample is located on the other side of a thin transparent substrate (for probe) which may be made, for example, of silicon dioxide or silicon nitride (or sapphire, diamond, or diamond-like material). The substrate may be, for example, 50-100 nm in thickness. The probe is lowered onto the back surface of the substrate until their contact by the system of control of the probe positioning with respect to the sample, e.g., in a way illustrated by FIG. 21 (illumination with radiation 24 and its reflection 27). Then radiation source 24 is switched off and the probe-tip apex 10 is bought in the contact with the back side of substrate 23. Radiation 30 is incident onto the sample, penetrates it, enters the substrate, and reaches the lower aperture of tip 10. Radiation 20 propagating in the probe reaches functional layer 17 illuminated with radiation 36 (e.g., quanta of the ultraviolet range). A quantum of radiation 31 transmitted by sample 4 is transformed into a quantum of radiation 20, which penetrates layer 18 and excites in it several quanta of radiation 39 recorded by a receiving objective of a scanning device. The advantage of this design is scanning (gliding) by the probe tip of the whole smooth surface of the back side of the substrate in contact with this surface. On the one hand, the whole process takes place in one plane, which facilitates the appropriate interpretation of the image. On the other hand, the process does not give rise to sample deformation (deterioration). Moreover, it provides sufficient flux of radiation 31 containing the useful information at the given point with the coordinate (x,y) without excessive spurious information, which increases the signal/noise ratio. In this case, the existence of a constant contact is provided by the mean for sample positioning. The probe can be “intentionally” pressed into the substrate with a certain safety factor. This ensures the absence of any gap between the tip and the substrate surface during horizontal scanning, which otherwise may be formed because of possible formation of an angle between the substrate plane and the plane of the device-holder motion.

According to some embodiments, a beneficial modification of a scanning device with the use of novel details, is the design with two probes facing one another with a sample on the substrate in between. In general, the probe generating the radiation incident onto the sample and recorded by the other probe may be a conventional light guide-based NSOIM probe. The second probe receiving the radiation may also be prepared from the light guide by a classical method. However, the spot size formed by a sharpened tip of this probe may be several times larger than the aperture at the probe tip. Therefore, an effective solution suggested in some embodiments is the use of cantilever probes on both sides (FIG. 22). Radiation 24a incident onto the lever from the back side of the lower probe is reflected by it as radiation 27a, and ensures the feedback for the control system of the probe (its tip) positioning with respect to sample 4. Radiation 26 passes through upper aperture 16a of lower tip substrate 8a, penetrates the lower probe, and propagates in it 20 to exit aperture 15a. Outgoing radiation 21 enters sample 4, is partly absorbed in it, and leaves the sample as radiation 31 containing the necessary information. Then radiation 31 enters aperture 15b, propagates 25 along the surface layer 13, and enters aperture 16b of upper tip substrate 8b. It leaves aperture 16b as radiation 32 received by the objective of a scanning device, and then is analyzed. Obviously, a scanning device illustrated by FIG. 18 allows one to obtain similar results also using the lower and not upper probe. In other words, the scanning device has two probes directed with their tips toward one another, with one of these tips providing the radiation incident onto the sample point (x,y) and the other receiving the radiation passed through this point. This device allows one to reduce noise, i.e., increase the signal/noise ratio and, thus, considerably increase the resolution power of the device. One of the most efficient variants of such a device has an “upper” probe moving along the well-developed surface relief of the sample a silicon probe with the tip with a small angle at the apex and the transparent silicon dioxide surface layer. As has already been indicated, this probe can penetrate all the relief details and, thus, reduces the probability of recording the radiation scattered from sample elements with the coordinates not coinciding with the coordinates of the apex of the lower probe tip. The lower probe may be made of silicon nitride and scans the sample of the flat substrate surface (its back side) being in constant contact with the substrate. If the substrate is also made of silicon nitride, then the effect of radiation refraction (scattering), which may take place at the interface between the two different materials is reduced. In this case, two types of radiation incidence onto the sample occur: through the lower probe with the recording of the radiation by the upper probe and vice versa. Another modification of this variant of the device is based on the use of epitaxially grown single-crystal whisker probes. The use of this method allows one to obtain a tip as high as 50 μl and even higher. In this case, a probe holder can be located parallel to the sample but without its contact with the sample. Then the tip axis is very perpendicular to the sample surface, which facilitates the radiation entrance (or exit) through the lower aperture normal to it, which also increases the resolution power of the device. The lower silicon nitride probe may also be located parallel to the substrate (i.e., to locate the tip axis normally to it) because, despite the small height of this tip, the flat substrate surface ensures the probe operation without any contact with the holder. The order of the sample preparation for scanning and the scanning itself may be as follows. The upper and lower probes are located (by the mean for positioning) so that they face one another. The adjustment (positioning) of the tips such that one tip generates the radiation detected by the other is performed until the attainment of the optimum signal/noise ratio. The probe coordinates are recorded by the computer the system of positioning control. It is also possible to use a special substrate without a sample. This substrate may be located between the tips of two probes. Once the substrate is placed, the probes may be brought away from one another for a considerable distance, and the substrate with the sample is introduced between the probes. Then the probes are brought into contact with the surfaces of the substrate and the sample. After these preliminary procedures, one starts scanning and working with the sample. Some embodiments envisage the transfer of the transitional motion during scanning through the device holder with the fixed substrate with a sample in such a way that the probe holders remain fixed with respect to the device. In other words, during scanning, probe holders are immobile, while the substrate moves. The tip of the lower probe is in contact with the surface, whereas the tip of the upper probe moves up and down following the surface relief of the sample. In some instances, it may be expedient to fix the tip of the upper probe at a certain distance from the sample. In other words, the tips of both probes remain immobile during the scanning process: the lower tip is in contact with the substrate surface, whereas the upper tip is at a certain distance from this surface.

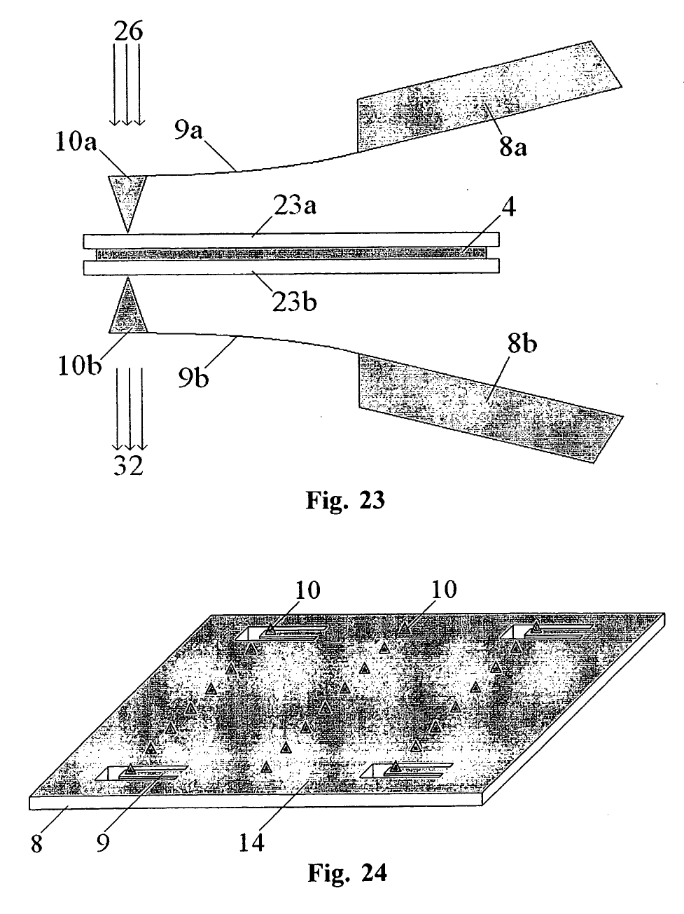

Some embodiments can also be used for recording the information onto an optical carrier and for its subsequent reading. As in the previous case, it may be advantageous to use two probes with the tips located opposite to one another. A sample (active material) is placed in between and is “clamped” in this position by two thin substrates. The sandwich thus obtained is contacted by the tips of both probes like a plate between two teeth of the upper and lower jaws (FIG. 23). In other words, both probe tips are in contact with substrates 23a,b of sample 4 on its two sides. In this case, radiation 26 incident onto the first probe and leaving it through the lower aperture penetrates sample 4 and enters the lower aperture of the other probe. The radiation from the second probe is recorded by the receiving objective (for example, see 12a on FIG. 14a) of the scanning device. Using intense radiation 26 and switching off (or taking aside) the receiving objective, one can vary sample properties. For example, it is possible to record the information on a carrier. Using a low-intensity radiation and switching-on the receiving objective, it is possible to consider the occurring process as reading of the information from the carrier.

It is also possible to implement a scheme in which the probe generates no radiation incident onto the sample. Instead, the probe generates the radiation incident onto the given point with the coordinates (x,y) and excites the characteristic radiation in the sample. Then the latter radiation may be recorded (received) and amplified by the receiving probe located on the other side of the sample.

Some embodiments are also applicable to the application of the lithography with a nanometer resolution. To increase the device efficiency it is possible to use at least two independent probes working in parallel or two pairs of probes in the case, where the probe tips in each pair of probes face one another. FIG. 24 illustrates a variant of such a design. Levers with tips are located along the substrate perimeter. This is made for the plane-parallel arrangement of the substrate with numerous tips with respect to the substrate with a sample (photoresist). This design allows one to use the actuators of the same type for the whole sample. Setting the distance between the tips on the substrate (not located on the flexible parts, i.e., on levers), one may vary the multiplication scale of the actuators of the same type over the whole sample surface. The distance between the tips may range from, for example about 1 μ to about 1000 μ and have even higher values.

### REFERENCES

1. K. Itsumi, M. Kourogi, and M. Ohtsu, Appl. Phys. Lett., 80, 2257 (2002)
2. W. Noell, M. Abraham, W. Ehrfeld, M. Lacher, and K. Mayr, J. Micromech. Microeng., 8, 111 (1998)
3. R. Eckert, J. Moritz Freyland, H. Gersen, H. Heinzelmann, G. Schurmann, W. Noell, U. Stauber, and Nico F. De Rooij, Appi. Phys. Lett., 77, 3695 (2000)
4. Shimada, et al., U.S. Pat. No. 6,201,226, Mar. 13, 2001
5. Shimada, et al., U.S. Pat. No. 6,333,497, Dec. 25, 2001
6. Sasaki et al., U.S. Pat. No. 6,469,288, Oct. 22, 2002
7. Sasaki et al., U.S. Pat. No. 6,545,276, Apr. 8, 2003
8. Bayeretal., U.S. Pat. No. 5,051,379, Sep. 24, 1991
9. Bayer et al., U.S. Pat. No. 5,242,541, Sep. 7, 1993
10. Givargizov et al., U.S. Pat. No. 6,458,206 B 1, Oct. 1, 2002

1. A tip device for a radiation scanning device, the tip device comprising:
a tip substrate comprising a material transparent to the radiation, wherein a portion of the substrate has a coating comprising a material non-transparent to the radiation; and
a tip formed on the substrate, wherein the tip comprises a lower aperture formed by an opening in the coating.

2. The tip device of claim 1, further comprising an upper aperture formed by another opening in the coating.

3. The tip device of claim 1, wherein the tip comprises a material transparent to the radiation.

4. The tip device of claim I wherein the coating on the substrate non-transparent to the radiation of the scanning device is transparent to another radiation.

5. The tip device of claim 1, further comprising means for generating radiation.

6. The tip device of claim 5, wherein at least a portion of the surface of the substrate comprises a luminescent layer configured to emit radiation in response to at least one of incident particles and incident radiation.

7. The tip device of claim 1, wherein the tip comprises a material transparent to the radiation having a first refractive index and the material of the substrate transparent to the radiation has a second refractive index, and the first and second refractive indexes are different.

8. The tip device of claim 7, wherein the material with the first refractive index is located in at least one of the tip bulk and the tip surface.

9. The tip device of claim 2 wherein the tip device is configured to transmit light between the upper and lower apertures.

10. The tip device of claim 1, configured to hold a sample substrate.

11. A method of manufacturing a tip device for a radiation scanning device, the method comprising:
forming a tip substrate comprising a material transparent to the radiation;
at least partially coating the substrate with a material non-transparent to the radiation;
forming a tip on the substrate; and
forming a lower aperture on the tip by creating an opening in the coating.

12. The method claim 11, wherein forming the tip comprises:
forming the tip from a tip transparent material; and
coating the tip transparent material with a non-transparent material,
wherein the tip is configured to transmit light through the tip and through the lower aperture.

13. The method of claim 11, wherein forming the lower aperture comprises removing a portion of the coating with a focused beam of particles.

14. The method of claim 11, wherein forming the lower aperture comprises mechanically removing a portion of the coating.

15. The method of claim 11, wherein forming the lower aperture comprises removing a portion of the coating through evaporation by application of an electric current to the coating near the portion of the coating to be removed.

16. The method of claim 11, wherein at least partially coating the substrate comprises applying the coating material to the substrate on a side opposite the side the tip is formed on.

17. The method of claim 11, further comprising forming means for generating radiation on at least one of the substrate and the tip.

18. A scanning device comprising:
a probe comprising the tip device of claim 1;
a substrate configured to support a sample, means for positioning the probe relative to the substrate;
means for scanning the sample;
means for inducing radiation from the sample;
means for amplifying the induced radiation; and
means for analyzing the induced radiation.

19. The scanning device of claim 18, further comprising means for controlled removal of a part of the coating material from the tip.

20. The scanning device of claim 18, wherein the probe is configured to enhance the induced radiation.

21. The scanning device of claim 18, wherein the means for probe positioning comprises means for modifying the sample.

22. A scanning device comprising:
a probe comprising:
a holder;
a lever;
a tip; and
an aperture formed on the tip by an opening in a layer of radiation-nontransparent material on the tip;
a substrate configured to support a sample, means for positioning the probe with respect to the substrate;
means for scanning the sample;
means for inducing radiation from the sample;
means for amplifying the induced radiation;
means for analyzing the induced radiation; and
first and second radiation sources configured to irradiate the sample.

23. The scanning device of claim 22, further comprising means for controlled removal of a part of the coating material from the tip.

24. The scanning device of claim 22, wherein at least one radiation source has a source of incoherent radiation.

25. The scanning device of claim 24, wherein the first and second radiation sources are positioned facing one another and the substrate is positioned between the first and second radiation sources.

26. The scanning device of claim 24, wherein at least one radiation source comprises a circular aperture.

27. The scanning device of claim 22, wherein at least one radiation source comprises a source of coherent radiation.

28. The scanning device of claim 27, further comprising means for generating and analyzing static or dynamic radiation interference.

29. The scanning device of claim 28, further comprising means for splitting the coherent radiation.

30. The scanning device of claim 29, wherein the probe comprises the means for splitting.

31. The scanning device of claim 22, wherein the probe comprises the means for amplifying the induced radiation.

32. A scanning device comprising:
a probe comprising:
a holder;
a lever;
a tip; and
an aperture formed on the tip by an opening in a layer of radiation-nontransparent material on the tip;
a substrate configured to support a sample, means for positioning the probe with respect to the substrate, the means for positioning configured to position the tip of the probe so as to contact the substrate on the opposite side of the substrate as the sample;
means for scanning the sample;
means for inducing radiation from the sample;
means for amplifying the induced radiation;
means for analyzing the induced radiation; and
first and second radiation sources configured to irradiate the sample.

33. The scanning device of claim 32, further comprising means for controlled removal of a part of the coating material from the tip.

34. The scanning device of claim 32, wherein the probe comprises the means for amplifying the induced radiation.

35. The scanning device of claim 32, wherein the probe and the substrate are formed of the same material.

36. The scanning device of claim 32, wherein the substrate is formed of a material which is softer than the tip of the probe.

37. The scanning device of claim 32, wherein the tip of the probe has a strengthening coating.

38. The scanning device of claim 32, further comprising means for cleaning a surface of the substrate opposite the sample.

39. The scanning device of claim 38, wherein the means for cleaning comprises a probe tip having a chemically active surface.

40. A scanning device comprising:
first and second probes, each comprising:
a holder;
a lever;
a tip; and
an aperture formed on the tip by an opening in a layer of radiation-nontransparent material on the tip;
a substrate configured to support a sample, means for positioning the first and second probes with respect to the substrate;
means for scanning the sample;
means for inducing radiation from the sample;
means for amplifying the induced radiation; and
means for analyzing the induced radiation,
wherein the tips of the first and second probes are oriented so as to face one another, the substrate is positioned between the first and second probe tips, the first probe is configured to transmit radiation, and the second probe is configured to receive the transmitted radiation.

41. The scanning device of claim 40, further comprising means for controlled removal of a part of the coating material from the tip.

42. The scanning device of claim 40, wherein the first probe comprises the means for inducing radiation from the sample.

43. The scanning device of claim 40, further comprising means for positioning the first probe relative to the second probe.

44. The scanning device of claim 40, wherein the first probe is configured to apply radiation to the sample, the second probe is configured to receive radiation from the sample, and the device is configured to record the received radiation.

45. The scanning device of claim 40, wherein the second probe is configured to receive and to amplify radiation.

46. The scanning device of claim 40, wherein the means for inducing radiation from the sample comprises at least two radiation sources.

47. The scanning device of claim 40, wherein the means for positioning is configured to position the tip of the probe so as to contact the substrate on the opposite side of the substrate as the sample.

48. The scanning device of claim 40, wherein the means for scanning is configured to scan the sample while the means for positioning positions the tip of the first probe to contact a first side of the substrate and positions the tip of the second probe to contact a second side of the substrate, the first side of the substrate being opposite the second side of the substrate.

49. The scanning device of claim 40, further comprising means for cleaning the substrate.

50. The scanning device of claim 49, wherein the means for cleaning comprises a probe tip having a chemically active surface.
